(19) United States
(12) Patent Application Publication
(10) Pub. No.: US 2016/0221754 A1
(43) Pub. Date: Aug. 4, 2016

(54) STORAGE MODULE AND CONNECTION SYSTEM

(71) Applicant: SKWARE, Creuzier Le Neuf (FR)

(72) Inventor: Thomas MIGNARD, Clermont-Ferrand (FR)

(21) Appl. No.: 15/022,257

(22) PCT Filed: Sep. 1, 2014
(86) PCT No.: PCT/FR2014/052153

§ 371 Date: Mar. 16, 2016

(30) Foreign Application Priority Data
Sep. 16, 2013 (FR) 1358891

(51) Int. Cl. B65G 1/02; F16B 12/38; A47B 57/40

(52) U.S. Cl. CPC B65G 1/02; A47B 57/408; F16B 12/38

(57) ABSTRACT

The present invention relates to a storage module comprising at least two vertical posts having at least one housing, and at least one shaft (2) the connection of which is ensured by a connection system (1) comprising: —A spindle (11) moving in relation to said shaft (2), capable of occupying a retracted position or a blocking position; —a return element (12) fixed on the said shaft (2) bringing back the said mobile spindle (11) toward the said blocking position; an actuation element (16) of said moving spindle (11) meeting the said return element (12); —a element (3) for positioning said shaft (2) on said vertical post, said positioning element having a laterally open profile in relation to said shaft and complementary in relation to a portion of said post.

### TECHNICAL FIELD

The present invention relates to a storage module and a connection system.

### BACKGROUND

The storage modules may be used in very various industries such as road transport or the medical sector.

It is known from the prior art to carry out these modules of metallic materials such as (thermo-coated, thermosetting overmolded, stainless, etc.) steel or aluminum (anodized, etc.).

Most steels can support heavy loads but remain unsuitable for some sectors, being subject to oxidation or corrosion. Furthermore, the use and the transport of modules constituted of such materials may lack practicality.

Stainless steels and aluminum, in turn, may not support heavy loads but are however more resistant to oxidation and corrosion. Nevertheless, the frequent cleanings and disinfections by using chemicals accelerate their deterioration. These materials are, furthermore, highly electrically conductive and may not be suitable for some industries.

Furthermore, the existing temporary fastening means are often not very ergonomic. For example, some modules allow the addition of a horizontal member only by removing the upper horizontal members beforehand. The mounting/dismantling time of this type of module thus proves to be generally significant.

In other prior designs of modules, the temporary fastening members of the horizontal members on the vertical members are bulky, and the net storage surface may be affected thereby.

Finally, some prior temporary fastening members have complex geometries. Particles may then easily become encrusted in the module which may be problematic in sectors such as medical or food sector. Furthermore, the cleaning of these modules may prove to be more difficult.

### BRIEF SUMMARY

The present invention aims to resolve all or part of the drawbacks aforementioned.

To this end, the present invention provides a connection system intended to be secured to a stringer and allow the temporary fastening of said stringer to a vertical post comprising at least one housing, including:
an movable axis movable relative to said stringer able to occupy a retracted position or a blocking position in which the translations and the rotations are blocked along two directions;
a return member fastened on said stringer returning said movable axis toward said blocking position;
an actuating member for actuating the movable axis opposite to said return member;
a positioning member arranged to define the relative position of said stringer on said vertical post, said positioning member having a profile laterally open relative to said stringer and complementary relative to a portion of said post.

This member allows the blocking in translation and in rotation along an axis.

During the mounting of said stringer on said vertical post, said positioning member allows in a first step to block said stringer in translation and in rotation along a direction. In a second step, said movable axis passing from its retracted position to its blocking position locks said stringer on said post, thus removing the other four degrees of freedom thereof, and thus immobilizing said stringer relative to said vertical post.

The profile laterally open relative to the stringer of said positioning member facilitates the mounting/dismantling of said stringer on said post in that it allows the positioning of said stringer on said vertical post in a single translation.

According to other optional features of the connection system according to the invention:
the material of the movable axis is selected from the group comprising composite material and metallic material;
when an operator displaces the actuating member along the axis of the movable axis against said return member, said return member is compressed and said movable axis occupies said retracted position;
when the operator releases said actuating member, said return member expands and returns said movable axis toward said blocking position;
the positioning member comprises a sleeve attached on said stringer;
said sleeve allows a reinforcement of the connection between said stringer and said post. Indeed, said sleeve allows a better distribution of forces and thus limiting the shear force which was exerted on said movable axis in the absence of said sleeve;
advantageously, at least one part of said sleeve is disposed around the stringer. Optionally, another part called securing part of said sleeve allows its fastening on said stringer. According to one embodiment of the invention, said stringer has a hollow profile and said securing part is inserted into said stringer;
the positioning member comprises at least one portion being able to be positioned on at least one bearing point of said vertical post;
the at least one portion is comprised in the open profile of the positioning member;
said portion is in the form of a tab, which may be received by a housing of said vertical post, said stringer now abutting against said vertical post and blocking the movement of said stringer in one direction;
said portion is in the form of an arm whose hooked end may be positioned on said vertical post and thus maintains said stringer abutting against said vertical post and blocks its movement in one direction;
said positioning member has at least one clearance allowing the displacement of said actuating member;
said sleeve comprises at least one clearance, allowing the displacement of said actuating member by an operator.

The present invention also relates to a storage module comprising at least two vertical posts comprising at least one housing, and at least one stringer, the connection of which is ensured by a system in accordance with the aforementioned connection system.

According to other optional features of the storage module according to the invention:
the material of said stringer and said vertical posts is selected from the group comprising synthetic composite material and synthetic material.

The composite synthetic members are lighter than the metallic members, and keep a similar resistance to loads. The composite synthetic materials and the synthetic materials are further very good resistant to corrosion and oxidation and very good electrical insulators.
The reinforcements of the composite material are fibrous;
said vertical posts have a closed profile;
a metallic insert is inserted at the periphery of said housing;
at least one bracing is installed between said vertical posts allowing a better stability of the assembly.

These dispositions according to the invention have many advantages. The mounting/dismantling operations are simplified and then time-saving. The arrangement of the positioning member allows, for example, the mounting/dismantling of said stringer when only one face of the module is accessible. A module may be then easily mounted <<between three walls >>. No space is wasted by the connection system, and it's very simple geometry will facilitate the cleaning operations. The device according to the invention may be then adapted to a large number of industries and different sectors.

### BRIEF DESCRPTION OF THE DRAWINGS

Other features and advantages of the present invention will appear in the light of the following description and by examining the appended figures, in which:

FIG. 1 represents the functional part of a connection system;

FIG. 2 represents the body of a vacuum connection system;

FIG. 3a represents a longitudinal section of a connection system joined to a stringer;

FIG. 3b represents a cross section of a connection system joined to a stringer;

FIG. 4a represents a stringer equipped with a connection system whose movable axis is in the blocking position;

FIG. 4b represents a stringer equipped with a connection system whose movable axis is in the retracted position;

FIG. 5a represents a vertical post;

FIG. 5b represents a housing in a vertical post reinforced by a metallic insert;

FIG. 6 represents a stringer equipped with a connection system mounted on a vertical post in a top view;

FIG. 7a represents a mounting operation of a stringer on a vertical post;

FIG. 7b represents a dismantling operation of a stringer from a vertical post;

FIG. 8 represents a storage module.

### DETAILED DESCRIPTION

In all of these figures, the identical or analogous references refer to components or assembly of identical or analogous components.

In this example, a connection system 1 is considered as being constituted of a functional part 10, a body 20 and a sleeve 3.

In FIG. 1, there is represented the functional part 10 of the connection system 1 which comprises a first movable axis 11, a spring 12, two buttons 13, 14 and a second cylindrical axis 15 ensuring the connection between the buttons and the first cylindrical axis.

The buttons 13, 14 and the second cylindrical axis 15 constitute the member 16 for actuating the movable axis 11.

The movable axis 11 may be made of metal or composite material.

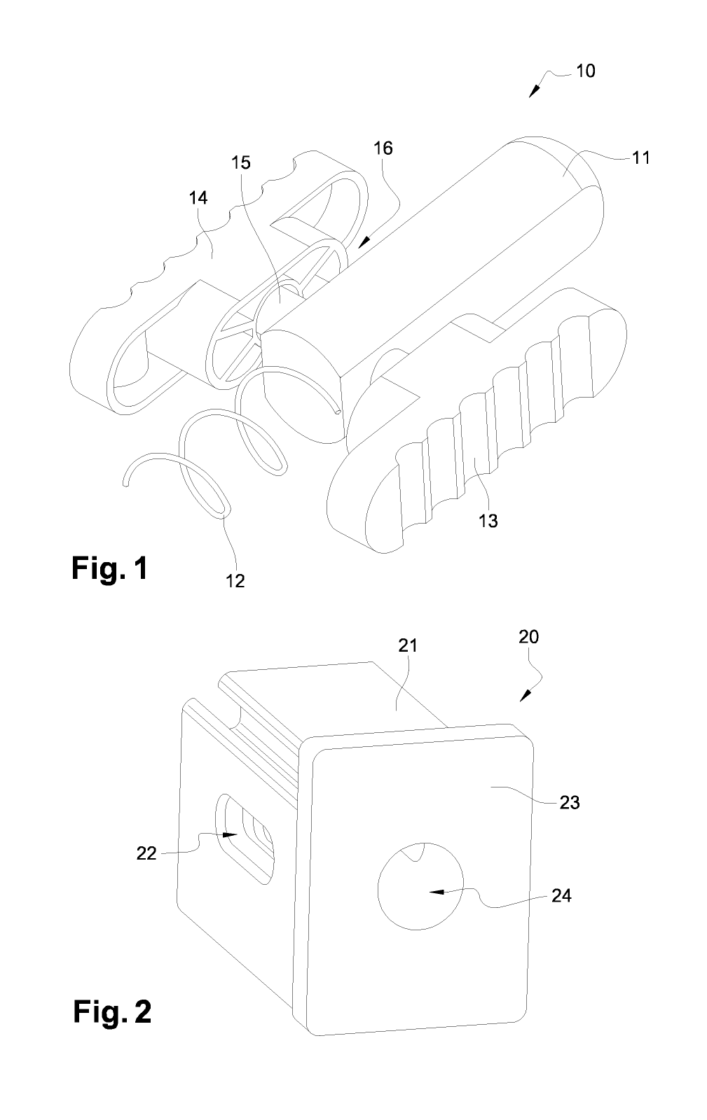

In FIG. 2, the body 20 of the vacuum connection system 1 is represented. The hollow body 20 will allow accommodating the functional part 10 of the connection system 1. The housing 22 is intended to accommodate a button 13, 14. The end 23 of the body 20 comprises a housing 24 intended to accommodate the movable axis 11. This body 20 is intended to be inserted into the stringer 2.

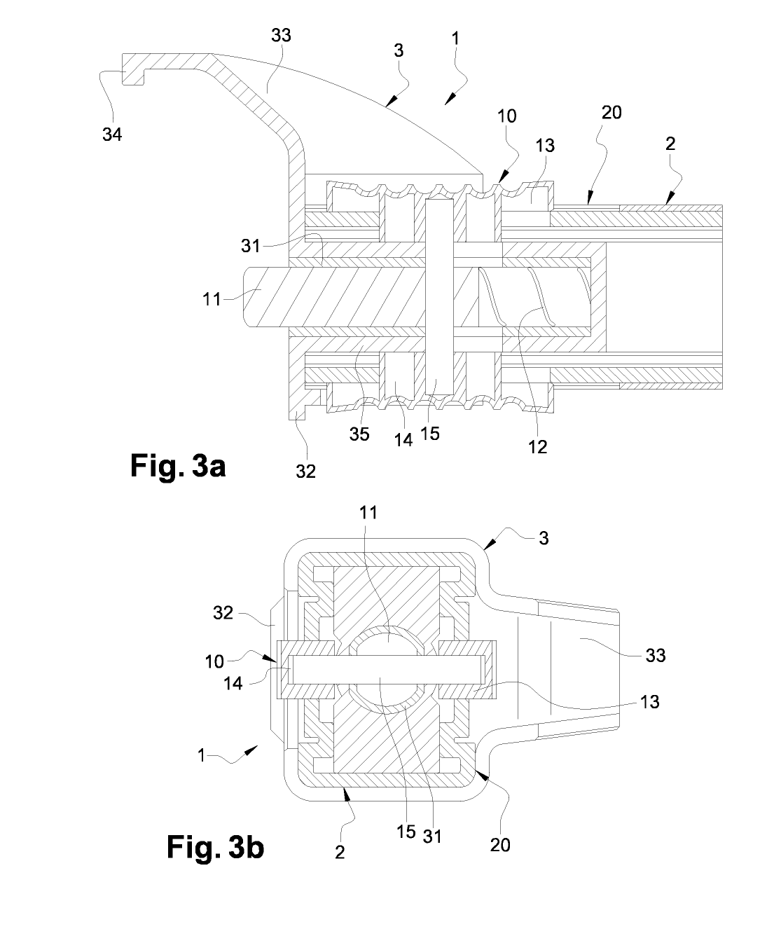

FIGS. 3a and 3b represent the connection system 1 inserted into the stringer 2. A sheath 31 of the body 10 of the connection system 1 allows the guiding of the return member 12 and the movable axis 11. The positioning member is herein represented in the form of a sleeve 3 surrounding the stringer 2. This sleeve 3 is constituted by a tab 32, an arm 33 whose end 34 is hooked and a member 35 intended to be inserted into the stringer 2 in order to secure the sleeve 3 and the stringer 2. The sleeve 3 is thus sleeved on the stringer 2. The tab 32 and the arm 33 are symmetrically opposite relative to the longitudinal axis of the stringer 2.

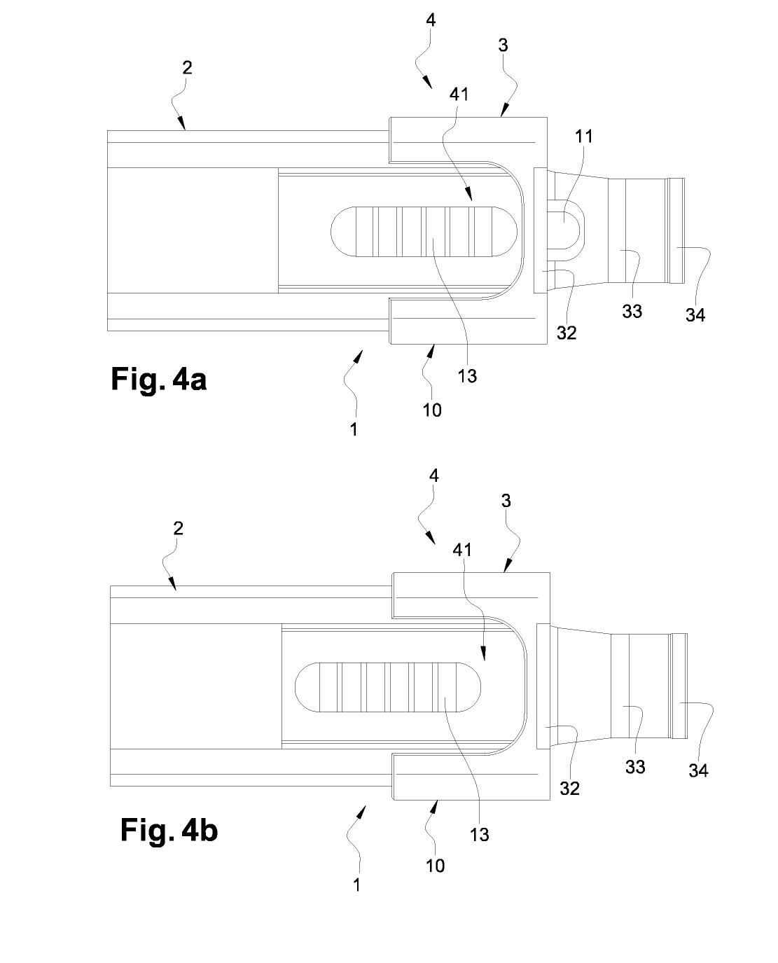

FIGS. 4a and 4b represent the assembly 4 comprising the connection system 1 and the stringer 2. FIG. 4a represents this assembly 4 whose movable axis 11 is in the blocking position. In this configuration, the buttons 13, 14 are released. FIG. 4b represents this same assembly 4 whose movable axis 11 is in the retracted position. In this configuration, the buttons 13, 14 are displaced in translation along the longitudinal axis of the stringer, possibly manually, so as to retract the movable axis. FIGS. 4a and 4b also highlight the geometry of the sleeve 3 which has a clearance 41, herein forming a U, in order to allow the translation of the buttons 13, 14.

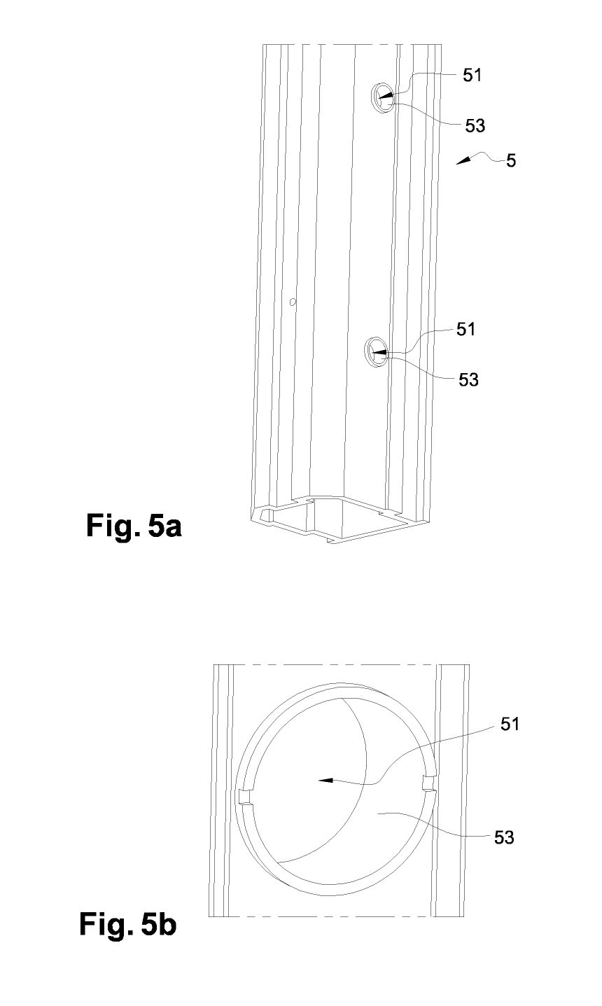

In FIG. 5a, a vertical post 5 made of composite material is represented. Its profile is herein closed, which gives a better traction and buckling resistance thereto. On its faces, the vertical post 5 comprises housings 51 intended to accommodate a movable axis 11 in the blocking position. The faces of the vertical post 5 also comprise grooves, intended to accommodate the tab 32 and the end 34 of the arm 33 of the sleeve 3. In order to avoid delamination and to limit the wear of the vertical post, a metallic insert 53, for example self-tapping, may be disposed at the periphery of these housings 51. Indeed, such insert 53 allows a better distribution of forces at the periphery of the housing.

The housing 51 accompanied with a metallic insert 53 is represented in close-up in FIG. 5b.

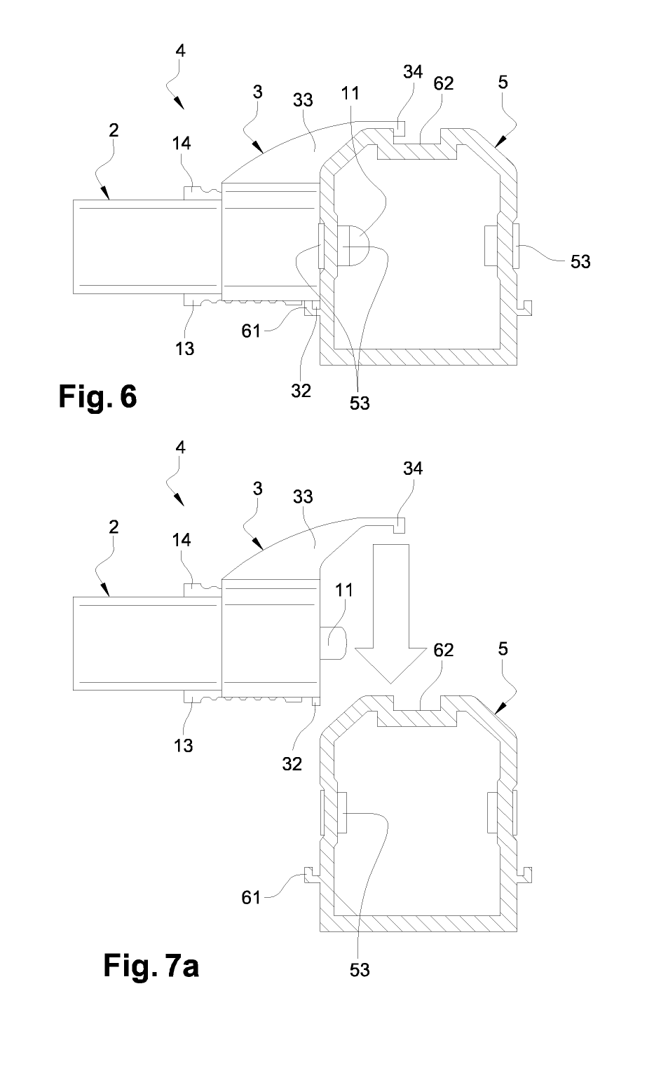

Reference is now made to FIG. 6. The assembly 4, comprising the stringer 2 and the connection system 1, is fastened to the vertical post 5. The tab 32 of the sleeve 3 is positioned in abutment in a housing 61 of the vertical post 5. The L-shape of this housing allows blocking the translation of the assembly 4 along the x axis and its rotation along the y axis and thus maintaining the stringer 2 fastened to the vertical post 5. This blocking in translation is reinforced by the end 34 of the arm 33 of the sleeve 3, positioned in abutment in a housing 62 of the vertical post 5. The form-fitting of the L-shape of the end 34 and of the U-shape of the housing 62 blocks the translation of the assembly 4 along the x axis and its rotation along the y axis in this second point. The movable axis 11 herein in the blocking position, allows preventing the translations along the y and z axes, and the rotations along the x and z axes.

As suggested in FIG. 6, several stringers 2 may be fastened both on the different faces of a vertical post 5.

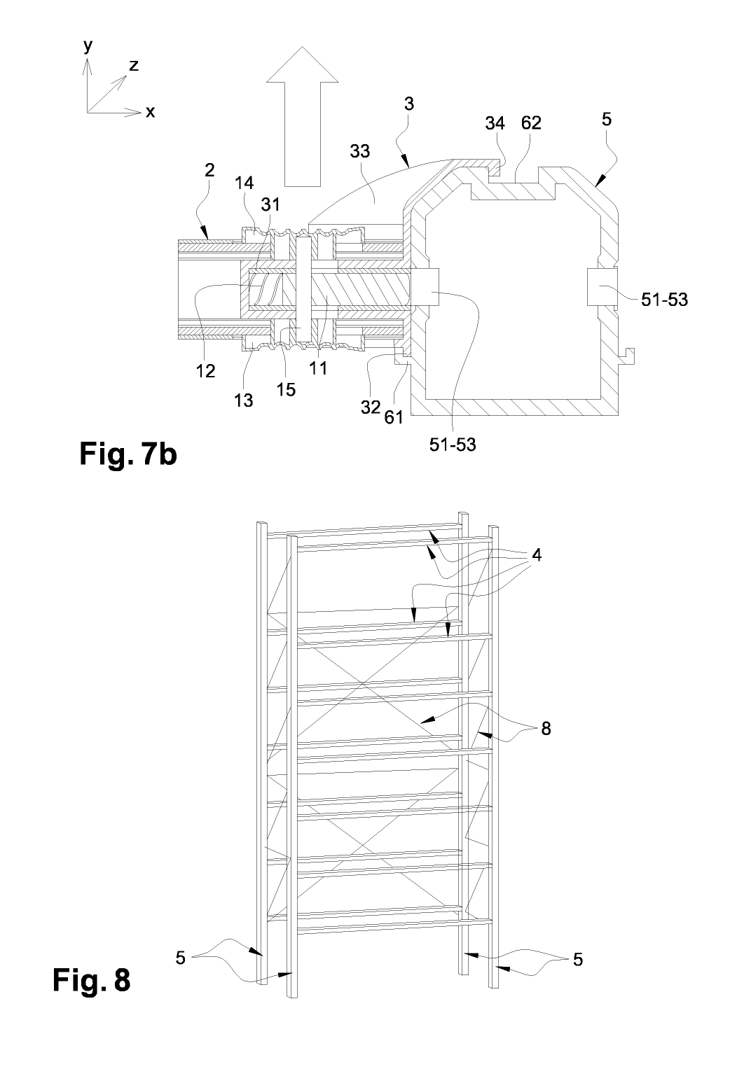

FIG. 7a represents the mounting operation of the assembly 4 on the vertical post 5. In a first step, the operator puts in position the assembly 4 so that the tab 32 and the end 34 of the arm 33 of the sleeve 3 are placed in abutment in the housings 61, 62 assigned thereto. In a second step, by using the buttons 13, 14, the operator slides the movable axis in the housing 51 provided for this purpose, so as it is located in the blocking position and locks the position of the assembly 4 on the vertical post 5.

FIG. 7b represents the dismantling operation of the assembly 4 from the vertical post 5. In a first step, by using the buttons, the operator slides the movable axis 11 so as to retract it, and thus unlocks the position of the assembly 4 on the post 5. In a second step, the operator removes the assembly 4 from its position by translating it along the y axis.

These FIGS. 7a and 7b also indicate that the positioning of the stringer 2 on the vertical post 5 may be accomplished due to a single translation. Indeed, the laterally open profile of the positioning member, herein the sleeve 3, allows the operator to mount/dismantle the stringer 2 having access only to one face of the storage module 8 represented in FIG. 8.

This example of storage module 8 may be mounted by using the members described hereinabove. Bracings 81 are represented between the vertical posts 5 and allow improving the rigidity of the module.

Of course, the present invention is not limited to the described and represented embodiment, provided as an illustrative and non-limiting example.

1. A connection system intended to be secured to a stringer and allow the temporary fastening of said stringer to a vertical post comprising at least one housing, including:
an movable axis movable relative to said stringer able to occupy a retracted position or a locking position;
a return member fastened on said stringer returning said movable axis toward said blocking position;
an actuating member for actuating said movable axis opposite to said return member;
a positioning member arranged to define the relative position of said stringer on said vertical post, said positioning member having a profile laterally open relative to said stringer and complementary relative to a portion of said post.

2. The system according to claim 1, wherein the movable axis is made of a composite or metallic material.

3. The system according to claim 1, wherein the positioning member comprises a sleeve attached on said stringer.

4. The system according to claim 1, wherein the positioning member comprises at least one portion being able to be positioned on at least one bearing point of said vertical post.

5. The system according to claim 4, wherein said portion is in the form of a tab which may be received by a housing of said vertical post.

6. The system according to claim 4, wherein said portion is in the form of an arm, the hooked end of which can be positioned on said vertical post.

7. The system according to claim 1, wherein said positioning member has at least one clearance allowing the displacement of said actuating member.

8. A storage module comprising at least two vertical posts comprising at least one housing, and at least one stringer the connection of which is ensured by a system in accordance with claim 1.

9. The module according to claim 8, wherein the material of said stringer and of said posts comprises at least one of synthetic composite material and synthetic material.

10. The module according to claim 8, wherein the reinforcements of the composite material are fibrous.

11. The module according to claim 8, wherein said vertical posts have a closed profile.

12. The module according to claim 8, wherein a metallic insert is inserted at the periphery of said housing.

13. The module according to claim 8, wherein at least one bracing is installed between said vertical posts.
